(19) United States
(12) Patent Application Publication
(10) Pub. No.: US 2016/0277258 A1
(43) Pub. Date: Sep. 22, 2016

(54) DISPLAY CONTROL APPARATUS, DISPLAY CONTROL SYSTEM, AND GRAPHICAL USER INTERFACE

(71) Applicant: Satoru Sugishita, Kanagawa (JP)

(72) Inventor: Satoru Sugishita, Kanagawa (JP)

(73) Assignee: Ricoh Company, Ltd., Tokyo (JP)

(21) Appl. No.: 15/069,369

(22) Filed: Mar. 14, 2016

(30) Foreign Application Priority Data
Mar. 19, 2015 (JP) 2015056672

(51) Int. Cl. H04L 12/26; H04L 12/24; G06F 3/0481

(52) U.S. Cl. CPC H04L 43/045; G06F 3/0481; H04L 43/10; H04L 41/0853

(57) ABSTRACT

A display control apparatus includes a search unit configured to search for one or more display apparatuses connected to a network; a notification unit configured to notify, in response to receiving an output request for outputting data from an information processing apparatus via the network, the information processing apparatus of usage statuses of the one or more display apparatuses obtained by the search unit; and an output control unit configured to cause a display apparatus, selected by the information processing apparatus among the one or more display apparatuses whose usage statuses have been notified from the notification unit, to output the data.

### CROSS-REFERENCE TO RELATED APPLICATION

The present application is based on and claims the benefit of priority of Japanese Priority Application No. 2015-056672 filed on Mar. 19, 2015, with the Japanese Patent Office, the entire contents of which are hereby incorporated by reference.

### BACKGROUND OF THE INVENTION

1. Field of the Invention

The disclosures herein generally relate to a display control apparatus, a display control system, and a graphical user interface.

2. Description of the Related Art

In a conventional TV conference system or a Web conference system, when a plurality of participants use a projecting device such as a projector in order to view data such as a material of the conference at the same time, a cable dedicated to the projecting device such a RGB cable is required. Further, when obtaining, from a personal computer (PC), various kinds of data such as the material of the conference to be projected by the projecting device, it is required to use a cable dedicated to the PC such as a universal serial bus (USB) cable.

Japanese Unexamined Patent Application Publication No. 2003-091490 discloses a method for causing a plurality of display devices to project the same content from a user interface provided on a TV conference system.

However, when holding the conference while causing the projecting devices to project the data such as the material of the conference, many cables are required as described above. Thus, arranging the projecting devices and the cables may take time, and space on a conference desk may become narrower due to the cables. Further, when the cable is broken or lost, the conference cannot be held. Thus, convenience to the user may be degraded.

### SUMMARY OF THE INVENTION

It is a general object of at least one embodiment of the present invention to provide a display control apparatus, a display control system, and a graphical user interface that substantially obviate one or more problems caused by the limitations and disadvantages of the related art.

An embodiment provides a display control apparatus including a search unit configured to search for one or more display apparatuses connected to a network; a notification unit configured to notify, in response to receiving an output request for outputting data from an information processing apparatus via the network, the information processing apparatus of usage statuses of the one or more display apparatuses obtained by the search unit; and an output control unit configured to cause a display apparatus, selected by the information processing apparatus among the one or more display apparatuses whose usage statuses have been notified from the notification unit, to output the data.

An embodiment also provides a graphical user interface executed in a display control system in which one or more display apparatuses configured to display data, an information processing apparatus configured to output the data to the one or more display apparatuses, and a display control apparatus configured to relay the data between the one or more display apparatuses and the information processing apparatus are connected to a network. The graphical user interface includes a cooperation management unit configured to obtain, from the display control apparatus, information of a user of the information processing apparatus who shares the data displayed by the one or more display apparatuses; and a screen generation unit configured to generate a screen for displaying, together with the data, the information of the user of the information processing apparatus obtained by the cooperation management unit.

### BRIEF DESCRIPTION OF THE DRAWINGS

FIG. 1 is schematic diagram illustrating a display control system according to an embodiment;

FIG. 2 is a block diagram illustrating an example of a hardware configuration of an image sharing apparatus according to the embodiment;

FIG. 3 is a block diagram illustrating an example of a functional configuration of the image sharing apparatus according to the embodiment;

FIG. 4 is a block diagram illustrating an example of a hardware configuration of an image information storage apparatus according to the embodiment;

FIG. 5 is block diagram illustrating an example of a functional configuration of the image information storage apparatus according to the embodiment;

FIG. 6 is a sequence chart illustrating a first example of a display process;

FIG. 7 is a sequence chart illustrating a second example of the display process;

FIG. 8 is a sequence chart illustrating a third example of the display process;

FIG. 9 is a sequence chart illustrating a fourth example of the display process;

FIG. 10 is a sequence chart illustrating a fifth example of the display process;

FIG. 11 is a drawing illustrating an example of a GUI displayed in the image information storage apparatus; and

FIG. 12 is a drawing illustrating an example of the GUI displayed by an image projection apparatus.

### DESCRIPTION OF THE PREFERRED EMBODIMENTS

In the following, embodiments of the present invention will be described with reference to the accompanying drawings.

<Schematic Configuration of a Display Control System 1>

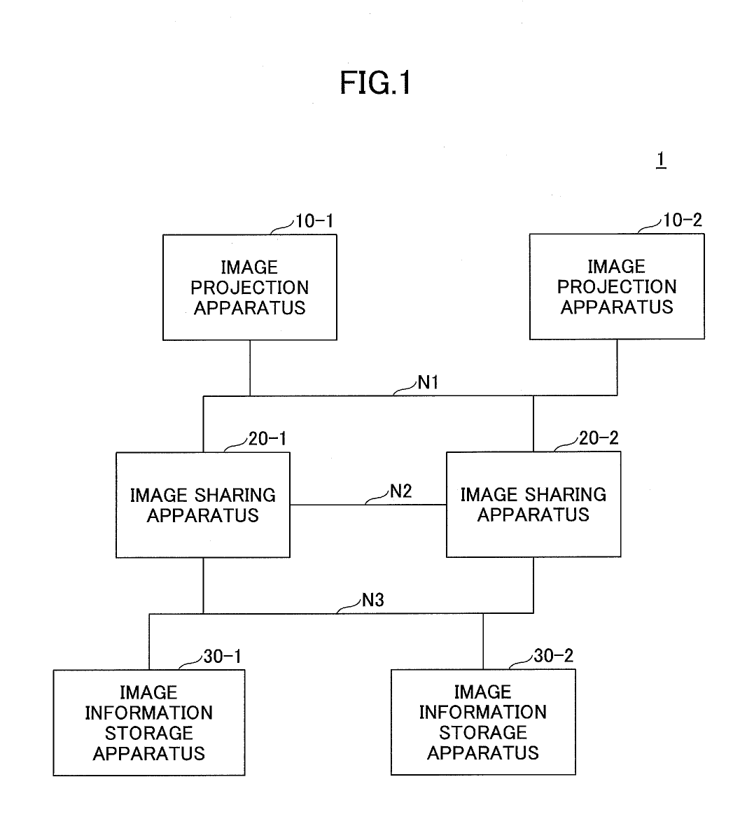

FIG. 1 is a schematic diagram illustrating a display control system 1 according to an embodiment. The display control system 1 shown in FIG. 1 includes image projection apparatuses 10 (in the example in FIG. 1, image projection apparatuses 10-1 and 10-2), as an example of one or more display apparatuses, image sharing apparatuses 20 (in the example in FIG. 1, image sharing apparatuses 20-1 and 20-2), as an example of one or more display control apparatuses, and image information storage apparatuses 30 (in the example in FIG. 1, image information storage apparatuses 30-1 and 30-2), as an example of one or more information processing apparatuses.

In the example shown in FIG. 1, the image sharing apparatuses 20 and the image projection apparatuses 10 are connected, for example, via a network N1. The image sharing apparatus 20-1 and the image sharing apparatus 20-2 are connected, for example, via a network N2. The image sharing apparatuses 20 and the image information storage apparatuses 30 are connected, for example, via a network N3. Although the networks N1 to N3 may be a communication network such as the Internet, the present invention is not limited to this.

The image projection apparatus 10 is an example of a display control apparatus that displays (projects) image data (for example, conference material) obtained from the image sharing apparatus 20. Although the image projection apparatus 10 may be a projector, the present invention is not limited to this. For example, a monitor, a television, or an electrical blackboard may be used as the image projection apparatus 10.

The image sharing apparatus 20 relays the image data and the like between the image projection apparatus 10 and the image information storage apparatus 30. The image information storage apparatus 30 is a supply source of the image data displayed by the image projection apparatus 10. For example, when being started, the image sharing apparatus 20 searches for usable image projection apparatuses 10 via the network N1 to notify the image information storage apparatus 30 via the network N3 of usage statuses of the image projection apparatuses 10. Further, when one or more image projection apparatuses 10, from which the image data are to be output, is designated (selected) by the image information storage apparatus 30, the image sharing apparatus 20 causes the designated (selected) one or more image projection apparatuses 10 to output the image data.

The image information storage apparatus 30 designates the one or more image projection apparatuses 10 via the image sharing apparatus 20. For example, the image information storage apparatus 30 searches for usable image sharing apparatuses 20 via the network N3 when being started, and transmits, to the image sharing apparatus 20, an output request for outputting the image data while designating the one or more image projection apparatuses 10, from which the image data are to be output, among the one or more image projection apparatuses 10 obtained from the image sharing apparatus 20. Although the image information storage apparatus 30 may be a PC, the present invention is not limited to this. A communication terminal such as a smartphone or a tablet terminal may be used as the image information storage apparatus 30.

As described above, in the display control system 1 shown in FIG. 1, the image information storage apparatus 30 obtains the usage statuses of the image sharing apparatuses 20 and the image information storage apparatuses 30 obtained by the network search to designate the one or more image projection apparatuses 10 via the image sharing apparatus 20. In this way, the number of dedicated cables between the image sharing apparatuses 20 and the image projection apparatuses 10, and the number of dedicated cables between the image sharing apparatuses 20 and the image information storage apparatuses 30 can be reduced. Further, the image data can be displayed using the image projection apparatuses 10. Thus, convenience of a user can be improved.

It should be noted that although the number of each of the apparatuses 10, 20, and 30 is two in the display control system 1 shown in FIG. 1, the present invention is not limited to this. For example, the number of each of the apparatuses 10, 20, and 30 may be three or more. Further, the number of each of the apparatuses 10, 20, and 30 is not necessarily the same. Further, although the display control system 1 may be a web conference system, the present invention is not limited to this. For example, the display control system 1 may be a web learning system or a telephone conference system.

<Hardware Configuration of the Image Sharing Apparatus 20>

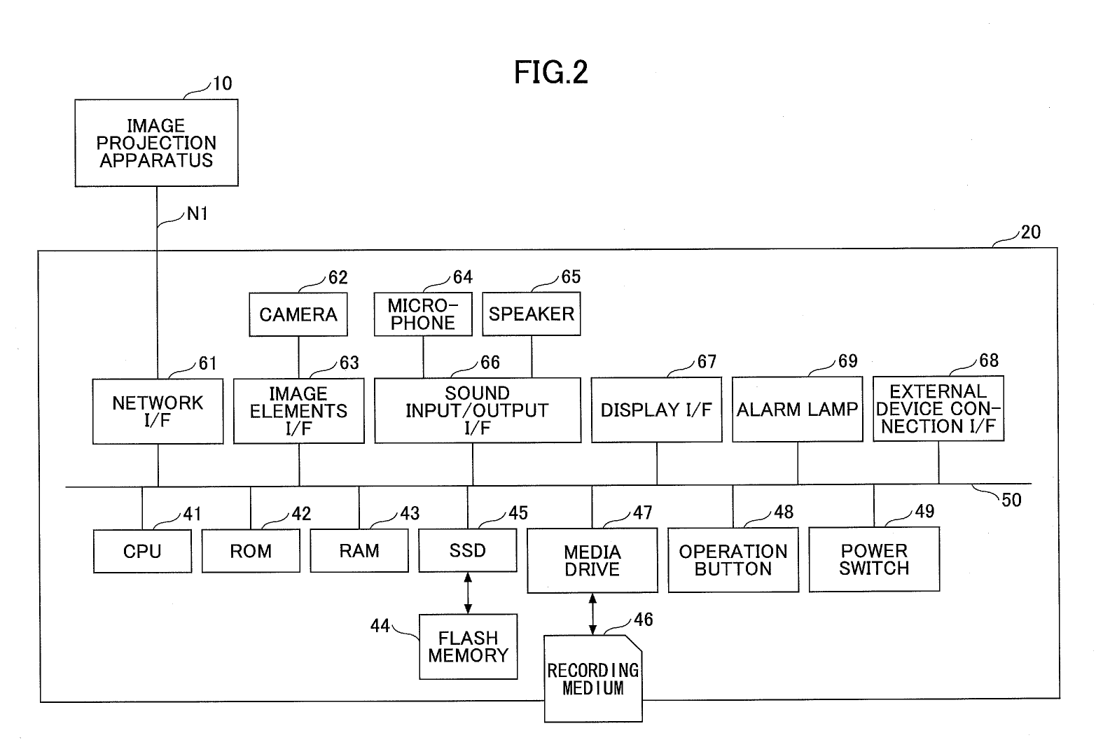

FIG. 2 is a block diagram illustrating an example of a hardware configuration of the image sharing apparatus 20 according to the embodiment. As shown in FIG. 2, the image sharing apparatus 20 includes a central processing unit (CPU) 41 that controls overall operation of the image sharing apparatus 20; a read-only memory (ROM) 42 that stores a display control program according to the embodiment, a random access memory (RAM) 43 used as a work area of the CPU 41, a flash memory 44 that stores various kinds of data, such as image data and voice data, a solid state drive (SSD) 45 that controls reading and writing (storing) of the various kinds of data from/to the flash memory 44 and the like according to the control of the CPU 41, a media drive 47 that controls reading and writing (storing) of data from/to a recording medium 46, an operation button 48, a power switch 49 for switching ON/OFF of the power of the image sharing apparatus 20, and a network interface (I/F) 61 for transmitting data using the networks N1 to N3. It should be noted that the SSD 45 may be a Hard Disk Drive (HDD).

Further, the image sharing apparatus 20 includes a built-in camera 62 that captures an object (for example, participants of a conference) to obtain image data according to the control of the CPU 41, an image elements interface (I/F) 63 that controls driving of the camera 62, a built-in microphone 64 that inputs audio sound, a built-in speaker 65 that outputs audio sound, a sound input/output interface (I/F) 66 that processes input/output of voice signals between the microphone 64 and the speaker 65 according to the control of the CPU 41, a display interface (I/F) 67 that transmits image data to an external display according to the control of the CPU 41, an external device connection interface (I/F) 68 for connecting various external devices to the image sharing apparatus 20, an alarm lamp 69 that informs the user of various functional problems of the image sharing apparatus 20, and a bus line 50 such as an address bus or a data bus for electrically connecting the elements with one another.

The network interface 61 connects the image sharing apparatus 20 to the plurality of image projection apparatuses 10 via the network N1.

The camera 62 includes a lens and solid-state image elements, which convert light into electric charges to obtain digital data of an image (video) of an object. For the solid-state image elements, for example, a CMOS (complementary metal oxide semiconductor), a CCD (charge coupled device), or the like is used.

External devices such as an external camera, an external microphone and an external speaker may be connected to the external device connection I/F 68 via a USB (Universal Serial Bus) cable or the like. When the external camera is connected to the external device connection I/F 68, the external camera is driven in priority to the built-in camera 62 according to control of the CPU 41. Similarly, when the external microphone or the external speaker is connected, the external microphone or the external speaker is driven in priority to the built-in microphone 64 or the built-in speaker 65 according to control of the CPU 41.

It should be noted that the recording medium 46 is attachable/detachable to/from the image sharing apparatus 20. Further, if the recording medium 46 is a non-volatile memory, from which data is read, or into which data is written according to the control by the CPU 41, not only the flash memory 44, but also an EEPROM (electrically erasable and programmable ROM) or the like may be used.

It should be noted that the display control program may be stored in an installable format or in an executable format on a computer-readable recording medium such as the recording medium 46. Further, the display control program may be stored in the ROM 42 instead of the flash memory 44.

<Functional Configuration of the Image Sharing Apparatus 20>

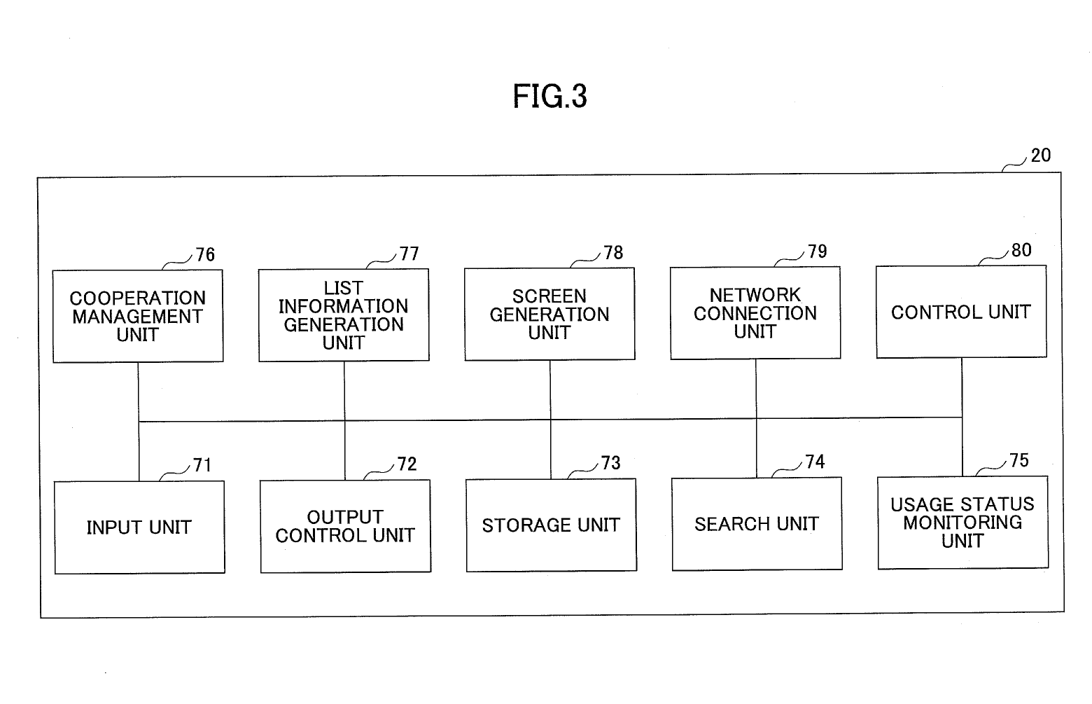

Next, a functional configuration of the image sharing apparatus 20 will be described with reference to FIG. 3. FIG. 3 is a block diagram illustrating the functional configuration of the image sharing apparatus 20 according to the embodiment. In the example shown in FIG. 3, the image sharing apparatus 20 includes an input unit 71, an output control unit 72, a storage unit 73, a search unit 74, a usage status monitoring unit 75, a cooperation management unit 76, a list information generation unit 77, a screen generation unit 78, a network connection unit 79, and a control unit 80.

The input unit 71 receives input of various instructions from the user who uses the image sharing apparatus 20. The output control unit 72 causes the image projection apparatus 10, which is designated by the image information storage apparatus 30, to output the image data. Further, the output control unit 72 causes the designated plurality of image projection apparatuses 10 to output the image data.

The storage unit 73 stores various kinds of data necessary for a display process according to the embodiment. The storage unit 73 stores, for example, address information (for example, IP addresses) for connecting, to the image sharing apparatus 20, the one or more image projection apparatuses 10, one or more other image sharing apparatuses 20, the one or more image information storage apparatuses 30, and the like, and various kinds of setting information for executing the display process according to first embodiment.

Although the storage unit 73 stores the image data obtained from the image information storage apparatus 30, the data stored in the storage unit 73 is not limited to this. The storage unit 73 can read and write various kinds of accumulated data as appropriate.

The search unit 74 searches for the one or more image projection apparatuses 10 existing on the network N1 after being started (for example, when powered on) or at fixed intervals. For example, when searching for the one or more image projection apparatuses 10, the search unit 74 obtains identification information of one or more image projection apparatuses 10 whose power are turned ON as a search result. Further, the search unit 74 may search for the one or more other image sharing apparatuses 20 existing on the network N2, or one or more image information storage apparatuses 30 existing on the network N3.

The usage status monitoring unit 75 monitors current usage statuses of the one or more image projection apparatuses 10 obtained by the search unit 74 (search result), and notifies the image information storage apparatus 30 of the search result. For example, the usage status monitoring unit 75 monitors whether the one or more image projection apparatuses is in a state of projecting (unusable state) or in a state of being ready to project (usable state), based on notifications from the one or more image projection apparatus 10.

The cooperation management unit 76 manages cooperation in the one or more image projection apparatuses 10 connected via the network N1, and manages cooperation in the one or more image information storage apparatuses 30 connected via the network N3. For example, in response to receiving, from the plurality of image information storage apparatuses 30, the output requests for requesting the same image projection apparatus 10 to output the image data, the cooperation management unit 76 synthesizes and/or switches the image data received from the plurality of respective image information storage apparatuses 30 to display the image data.

Further, in in response to receiving, from the image information storage apparatus 30, additional designation for using another image sharing apparatus 20 (designation for adding another image sharing apparatus 20), the cooperation management unit 76 manages cooperation in order to share the image data with the other image sharing apparatus 20. Further, the cooperation management unit 76 may cooperate with the other image sharing apparatus 20 to obtain information of the user of the image information storage apparatus 30 who uses the other image sharing apparatus 20.

The list information generation unit 77 generates list information (list) of the image projection apparatuses 10 based on the information (search result and usage status) obtained from the search unit 74 and the usage status monitoring unit 75 to notify the image information storage apparatus 30. In other words, the list information generation unit (updating unit) 77 updates the list about the usage statuses of the one or more image projection apparatuses 10 based on a change of at least one of the one or more display apparatuses from a usable state to an unusable state and a change of at least one of the one or more display apparatuses from the unusable state to the usable state.

The screen generation unit 78 generates a graphical user interface (GUI) screen that includes the list information generated by the list information generation unit 77. The GUI screen is transmitted to the image information storage apparatus 30. For example, the screen generation unit 78 generates a screen for selecting the image projection apparatuses 10 from the list information obtained by the list information generation unit 77, and transmits the screen to the image information storage apparatus 30.

Further, when causing the image projection apparatus 10 to display the image data, the screen generation unit 78 obtains information of the user (information of participants) who shares the image data from the cooperation management unit 76, and generates the screen in which the information of the user is displayed together with the image data to transmit the screen, for example, to the image projection apparatus 10 and/or the image information storage apparatus 30.

The network connection unit 79 is a communication interface for connecting the image sharing apparatus 20 to the one or more image projection apparatuses 10, the one or more other image sharing apparatuses 20, and the one or more image information storage apparatuses 30 via the network N1 to N3.

The control unit 80 controls the entire configuration of the image sharing apparatus 20. The control unit 80 performs control when starting and finishing the display process, control when being started, control when an error occurs, and the like. It should be noted that control contents performed by the control unit 80 are not limited to this.

<Hardware configuration of the image information storage apparatus 30>

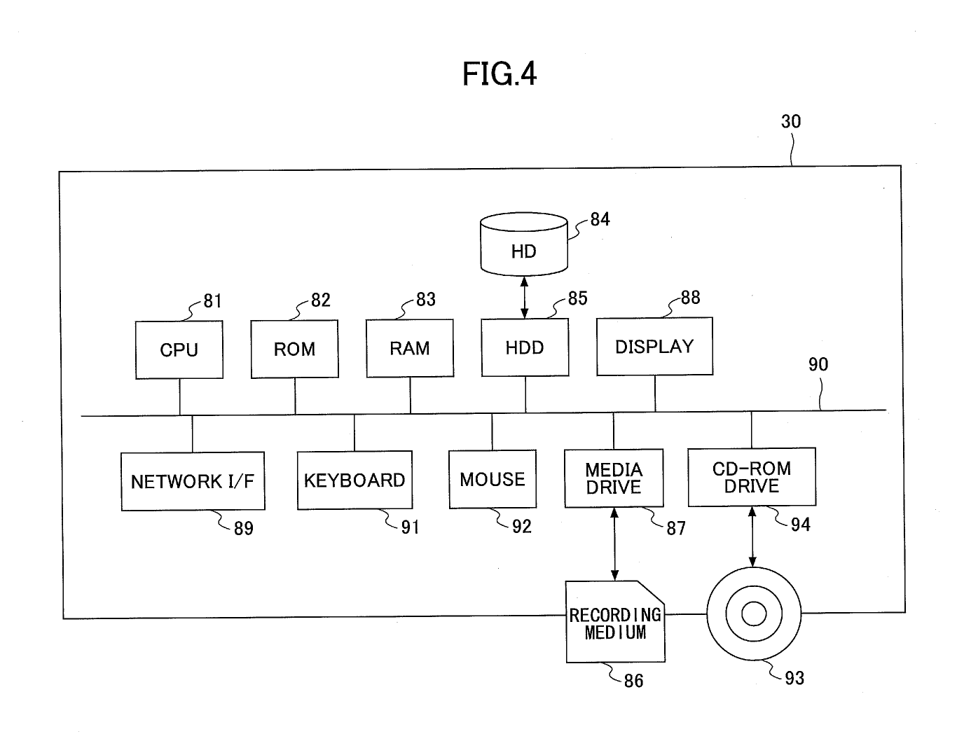

Next, a hardware configuration of the image information storage apparatus 30 will be described with reference to FIG. 4. FIG. 4 is a block diagram illustrating an example of the hardware configuration of the image information storage apparatus 30 according to the embodiment.

As shown in FIG. 4, the image information storage apparatus 30 includes a central processing unit (CPU) 81 that controls overall operation of the image information storage apparatus 30, a read-only memory (ROM) 82 that stores a display control program according to the embodiment, a random access memory (RAM) 83 used as a work area of the CPU 81, a hard disk (HD) 84 that stores various kinds of data, a hard disk drive (HDD) 85 that controls reading and writing (storing) of the various kinds of data from/to the HD 84 according to the control of the CPU 81, a media drive 87 that controls reading and writing (storing) of data from/to a recording medium 86 such as a flash memory, a display 88 that displays various kinds of information such as a cursor, menus, windows, characters and images, a network interface (I/F) 89 for transmitting data using the network 3, a keyboard 91 including a plurality of keys for inputting the characters, numerals, and various instructions, a mouse 92 for selecting or executing various instructions, selecting items to be processed, and moving the cursor, a CD-ROM drive 94 that controls reading and writing of data from/to a compact disk read-only memory (CD-ROM) 93 as an example of a removable recording medium, and a bus line 90 such as an address bus or a data bus for electrically connecting the elements with one another.

It should be noted that the display control program may be stored in an installable format or in an executable format on a computer-readable recording medium such as the recording medium 86 or the CD-ROM 93. Further, a computer-readable recording medium such as a compact disc recordable (CD-R), a digital versatile disc (DVD), a Blu-ray disc may be used for providing.

<Functional Configuration of the Image Information Storage Apparatus 30>

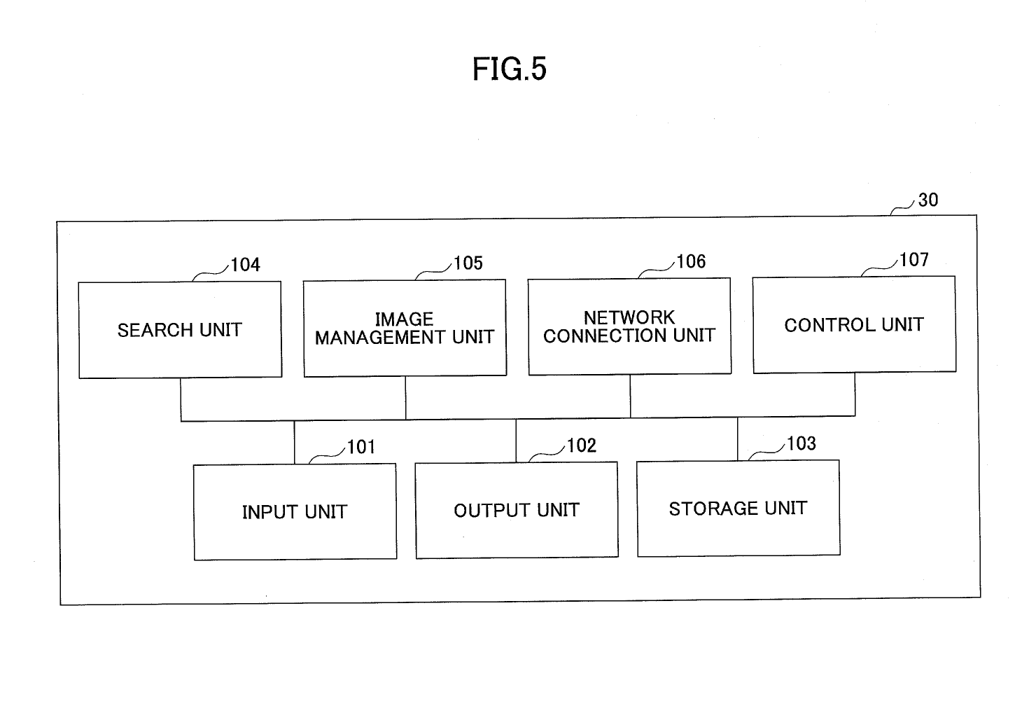

Next, a functional configuration of the image information storage apparatus 30 will be described with reference to FIG. 5. FIG. 5 is a block diagram illustrating an example of the functional configuration of the image information storage apparatus 30 according to the embodiment. The image information storage apparatus 30 shown in FIG. 5 includes an input unit 101, an output unit 102, a storage unit 103, a search unit 104, an image management unit 105, a network connection unit 106, and a control unit 107.

The input unit 101 receives input of various instructions from the user who uses the image information storage apparatus 30. The input unit 101 may include a pointing device such as a keyboard and a mouse. The output unit 102 displays and outputs content (information and/or data) input from the input unit 101 and content executed based on the input content. The output unit 102 may include a display and/or a speaker. It should be noted that the input unit 101 and the output unit 102 may be an integrated input/output unit such as a touch panel.

The storage unit 103 stores various kinds of data necessary for the display process according to the embodiment. The storage unit 103 stores, for example, address information (such as IP address) for connecting, to the image information storage apparatus 30, the one or more image sharing apparatuses 20 and the like, and various kinds of setting information for executing the display process according to the embodiment. However, information and data stored in the storage unit 103 are not limited to this. It should be noted that the storage unit 103 can read and write various kinds of accumulated data as appropriate.

The search unit 104 searches for the one or more image sharing apparatuses 20 existing on the network N3 after being started or at predetermined timing (for example, when instruction to start sharing the image is executed). For example, when searching for the one or more image sharing apparatuses 20, the search unit 104 obtains information including usage statuses (usable or not) of the one or more image sharing apparatuses and identification information of one or more image sharing apparatuses 20 whose power are turned ON as a search result. Further, the search unit 104 may cause the output unit 102 to display the usage statuses obtained from the one or more respective image sharing apparatuses 20 as the list information (list) of the image sharing apparatuses 20.

The image management unit 105 manages sharable image data (for example, materials viewed in an electronic conference). When the list of the one or more usable image projection apparatuses 10 or the screen being projected by the image projection apparatus 10 is transmitted from the image sharing apparatus 20, the image management unit 105 causes the output unit 102 to display the list or the screen.

The network connection unit 106 is a communication interface for connecting the image information storage apparatus 30 to the image sharing apparatuses 20 and the like via the network N3.

The control unit 107 controls the entire configuration of the image information storage apparatus 30. The control unit 107 performs control when starting and finishing the display process, control when being started, control when an error occurs, and the like. It should be noted that control contents by the control unit 107 are not limited to this.

<Example of the Display Process According to the Display Control System 1>

Next, examples of the display process of the display control system 1 according to the embodiment will be described.

<First Example of the Display Process>

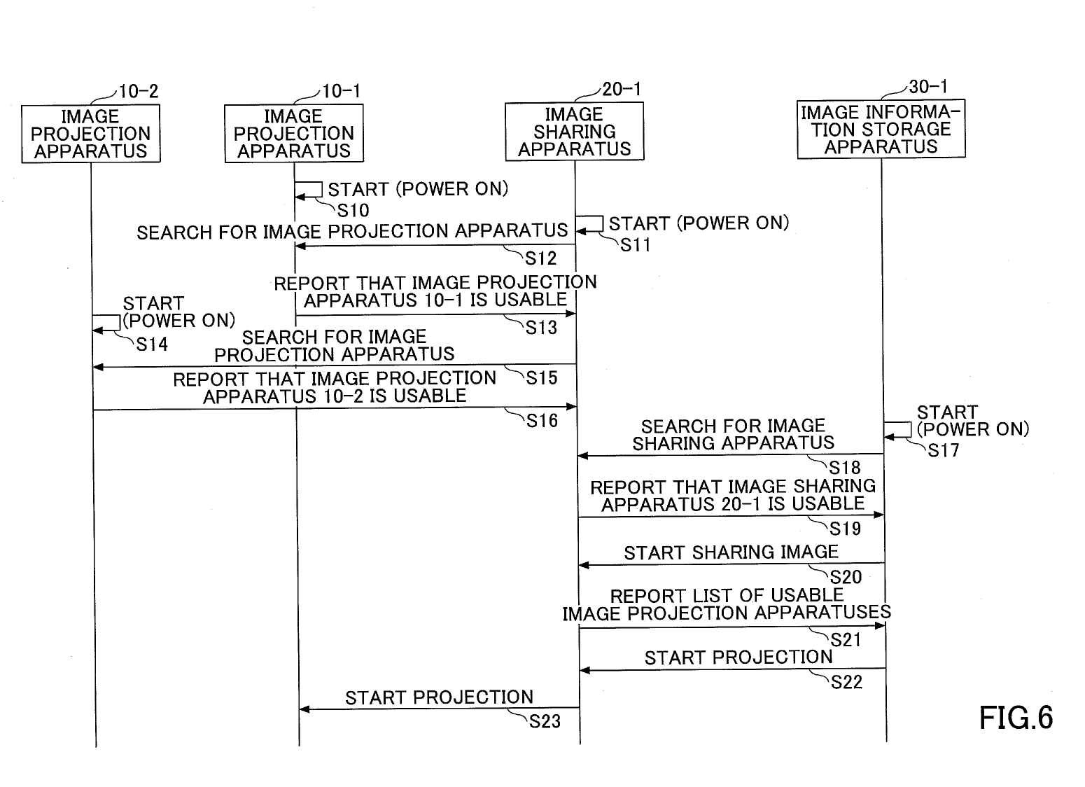

FIG. 6 is a sequence chart illustrating a first example of the display process. The sequence shown in FIG. 6 is executed by the two image projection apparatuses 10-1 and 10-2, the image sharing apparatus 20-1, and the image information storage apparatus 30-1.

As shown in FIG. 6, when being started (power ON) in step S11 after the image projection apparatus 10-1 is started (power ON) in step S10, the image sharing apparatus 20-1 searches for one or more usable image projection apparatuses 10 via the network N1 in step S12. At this time, because the image projection apparatus 10-1 is being activated, the image projection apparatus 10-1 notifies the image sharing apparatus 20-1 that the image projection apparatus 10-1 is usable in step S13. It should be noted that, because the image projection apparatus 10-2 is not started at this time, the image projection apparatus 10-2 processes nothing.

It should be noted that the above described process in step S13 may be executed at predetermined time intervals regularly. Further, when the image sharing apparatus 20-1 searches for the one or more usable image projection apparatuses 10 via the network N1 in step S15 after the image projection apparatus 10-2 is started (power ON) in step S14, the image projection apparatus 10-2 notifies the image sharing apparatus 20-1 that the image projection apparatus 10-2 is usable in step S16.

It should be noted although the image sharing apparatus 20-1 automatically searches for the image projection apparatuses 10-1 and 10-2 via the network N1 in the above described process in steps S12 to S16, one or more image projection apparatuses 10 (search targets) to be searched for may be registered previously.

When the being started (power ON) in step S17, the image information storage apparatus 30-1 searches for the one or more usable image sharing apparatuses 20 via the network N3 in step S18. The image sharing apparatus 20-1 notifies the image information storage apparatus 30-1 that the image sharing apparatus 20-1 is usable in step S19. It should be noted although the image information storage apparatus 30-1 automatically searches for the image sharing apparatus 20-1 via the network N3 in the process in step S18, one or more image sharing apparatuses 20 (search target) to be searched for may be registered previously.

When sharing an image, the image information storage apparatus 30-1 instructs the image sharing apparatus 20-1 to start sharing the image via the network N3 in step S20. In response to receiving the instruction from the image information storage apparatus 30-1, the image sharing apparatus 20-1 generates a list of currently usable image projection apparatuses 10, and notifies the image information storage apparatus 30-1 of the list in step S21. In this case, the image projection apparatuses 10-1 and 10-2 are usable.

When the image projection apparatus 10-1 desired to be used is designated among the one or more image projection apparatuses 10 included in the list, the image information storage apparatus 30-1 transmits, to the image sharing apparatus 20-1 in step S22, the identification information of the image projection apparatus 10-1 and the image data to be shared together with an instruction for starting projection.

In response to receiving the instruction for starting the projection from the image information storage apparatus 30-1, the image sharing apparatus 20-1 transmits, to the image projection apparatus 10-1, the image data to be shared and the like, and causes the image projection apparatus 10-1 to start projecting the image data in step S23. In this way, the image projection apparatus 10-1 projects the image data obtained from the image sharing apparatus 20-1.

As described above, according to the first example, the image information storage apparatus 30-1 requests the image sharing apparatus 20-1 to start the projection while designating the image projection apparatus 10-1 desired to be used. It should be noted that although the image sharing apparatus 20-1 searches for the image projection apparatuses 10 immediately after being started in the first example, the image sharing apparatus 20 may search for the image projection apparatuses 10 at timing when the instruction for starting sharing the image from the image information storage apparatus 30 is notified, for example.

Further, according to the first example, because the image sharing apparatus 20-1 and the image projection apparatuses 10-1 and 10-2 are not required to connect with each other in one-to-one correspondence via a RGB cable or the like, a conference system can be structured with small numbers of cables to be used. Further, because the one or more image projection apparatuses 10 desired to be used can be designated, an image projection apparatus 10 positioned at a remote area, which cannot be selected in a conventional method, can be used.

Further, even in a conference room in which one or more image projection apparatuses 10 are arranged on a ceiling, the conference can be held without using the cables, and options of a place where the conference is held are increased. Further, because the image projection apparatuses 10 are not required to be registered preciously, the image sharing apparatus 20 may be taken into another building to be used.

Further, by notifying the image information storage apparatus 30-1 of the usage statuses of the image projection apparatuses 10 and the image sharing apparatus 20, access to the image projection apparatus 10 during the projection and access to the image sharing apparatus 20 during the conference can be prevented. Thus, according to the first example, the convenience of the user can be improved.

<Second Example of the Display Process>

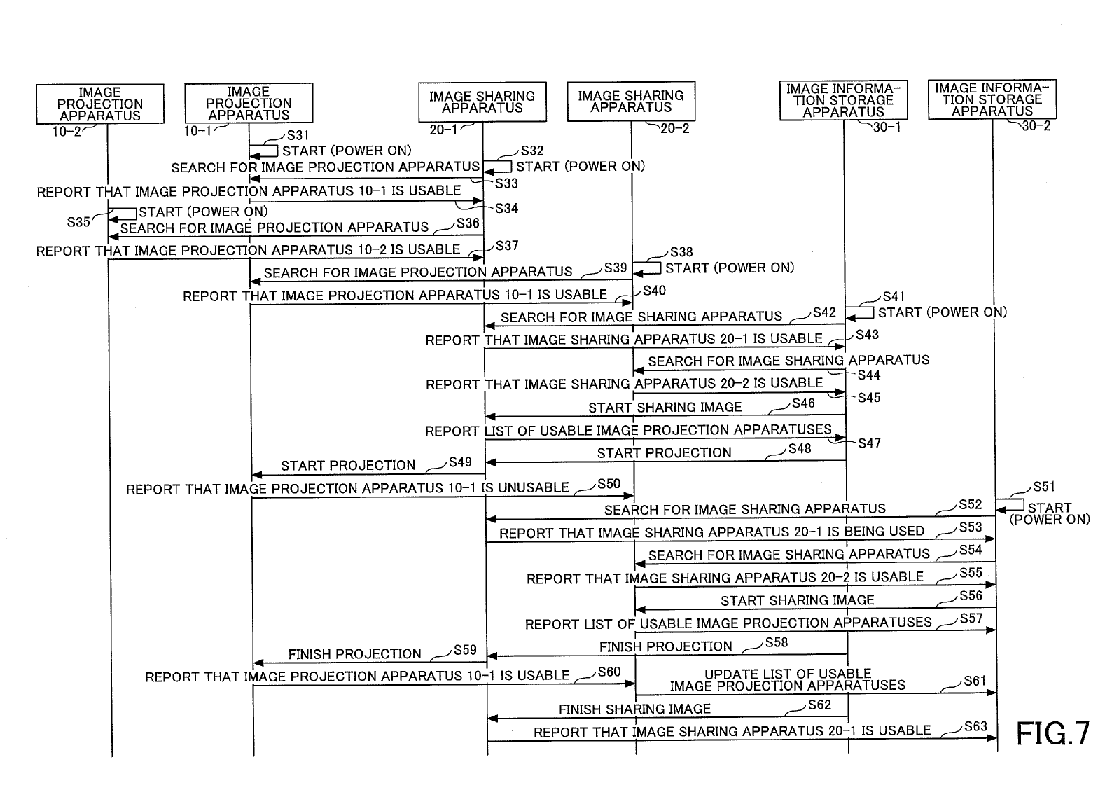

FIG. 7 is a sequence chart illustrating a second example of the display process. In the example shown in FIG. 7, the usage statuses of the image projection apparatuses 10-1 and 10-2 and the image sharing apparatuses 20-1 and 20-2 are notified to the image information storage apparatuses 30-1 and 30-2. It should be noted that the sequence shown in FIG. 7 is executed by the image projection apparatuses 10-1 and 10-2, the image sharing apparatus 20-1 and 20-2, and the image information storage apparatus 30-1 and 30-2.

As shown in FIG. 7, when being started (power ON) in step S32 after the image projection apparatus 10-1 is started (power ON) in step S31, the image sharing apparatus 20-1 searches for one or more usable image projection apparatuses 10 via the network N1 in step S33. Because the image projection apparatus 10-1 is being activated, the image projection apparatus 10-1 notifies the image sharing apparatus 20-1 that the image projection apparatus 10-1 is usable in step S34.

Further, when the image sharing apparatus 20-1 searches for the one or more usable image projection apparatuses 10 via the network N1 in step S36 after the image projection apparatus 10-2 is started (power ON) in step S35, the image projection apparatus 10-2 notifies the image sharing apparatus 20-1 that the image projection apparatus 10-2 is usable in step S37.

Further, when the image sharing apparatus 20-2 searches for the one or more usable image projection apparatuses 10 via the network N1 in step S39 after being started (power ON) in step S38, the image projection apparatus 10-1 notifies the image sharing apparatus 20-2 that the image projection apparatus 10-1 is usable in step S40. It should be noted that in the example shown in FIG. 7, the image sharing apparatus 20-2 is not notified that the image projection apparatus 10-2 is usable from the image projection apparatus 10-2. This indicates that a search condition of the image sharing apparatus 20-1 and a search condition of the image sharing apparatus 20-2 are different and the image projection apparatus 10-2 does not satisfy the search condition of the image sharing apparatus 20-2.

Next, when the image information storage apparatus 30-1 searches for one or more usable image sharing apparatuses 20 via the network N3 in step S42 after being started (power ON) in step S41, the image sharing apparatus 20-1 notifies the image information storage apparatus 30-1 that the image sharing apparatus 20-1 is usable in step S43. Similarly, when the image information storage apparatus 30-1 searches for the one or more usable image sharing apparatuses 20 via the network N3 in step S44, the image sharing apparatus 20-2 notifies the image information storage apparatus 30-1 that the image sharing apparatus 20-2 is usable in step S45.

In step S46, the image information storage apparatus 30-1 instructs the image sharing apparatus 20-1, which the image information storage apparatus 30-1 desires to use, to start sharing the image. The image sharing apparatus 20-1, which receives the instruction, notifies the image information storage apparatus 30-1 of the list of usable image projection apparatuses 10 in step S47. When the image projection apparatus 10-1 desired to be used is designated from the list, the image information storage apparatus 30-1 transmits, to the image sharing apparatus 20-1 in step S48, the identification information of the image projection apparatus 10-1 and the image data to be shared together with instruction for starting projection.

In response to receiving the instruction for starting the projection from the image information storage apparatus 30-1, the image sharing apparatus 20-1 transmits, to the image projection apparatus 10-1, the image data to be shared and the like, and causes the image projection apparatus 10-1 to start projecting the image data in step S49.

When starting to project the image data, the image projection apparatus 10-1 notifies the image sharing apparatus 20-2, to which it has been notified that the image projection apparatus 10-1 is usable in the process in step S40, that the image projection apparatus 10-1 is unusable in step S50.

Next, when the image information storage apparatus 30-2 searches for the usable image sharing apparatus 20-1 via the network N3 in step S52 after being started (power ON) in step S51, the image sharing apparatus 20-1 notifies the image information storage apparatus 30-2 that the image sharing apparatus 20-1 is being used in step S53. Further, when the image information storage apparatus 30-2 searches for the usable image sharing apparatus 20-2 via the network N3 in step S54, the image sharing apparatus 20-2 notifies the image information storage apparatus 30-2 that the image sharing apparatus 20-2 is usable in step S55.

When the image information storage apparatus 30-2 instructs the image sharing apparatus 20-2 to start sharing the image in step S56, the image sharing apparatus 20-2 notifies the image information storage apparatus 30-2 of the list of the one or more usable image projection apparatuses 10 in step S57. At this time, because the image projection apparatus 10-1 is being used, the he image projection apparatus 10-1 is unusable.

Here, when the image information storage apparatus 30-1 notifies the image sharing apparatus 20-1 of finishing the projection in step S58, the image sharing apparatus 20-1 notifies the image projection apparatus 10-1 of finishing the projection in step S59. In response to this, the image projection apparatus 10-1 notifies the image sharing apparatus 20-2 that the image projection apparatus 10-1 is usable in step S60. Then, the image sharing apparatus 20-2 updates the list of the one or more usable image projection apparatuses 10, and notifies the image information storage apparatus 30-2 of the list in step S61.

Further, when the image information storage apparatus 30-1 instructs the image sharing apparatus 20-1 to finish sharing the image in step S62, the image sharing apparatus 20-1 notifies the image information storage apparatus 30-2 that the image sharing apparatus 20-1 is usable in step S63.

As described above, according to the second example, in a case in which the image sharing apparatus 20-1 is anew searched for by the image information storage apparatus 30-2 (another apparatus) after the image sharing apparatus 20-1 is instructed to start sharing the image from the image information storage apparatus 30-1, the image sharing apparatus 20-1 notifies the image information storage apparatus 30-2 that the image sharing apparatus 20-1 is being used. Further, after finishing sharing the image, the image sharing apparatus 20-1 notifies the image information storage apparatus 30-2 that the image sharing apparatus 20-1 becomes usable. Further, when the image projection apparatus 10-1 is instructed to start the projection from the image sharing apparatus 20-1, the image projection apparatus 10-1 notifies the image sharing apparatus 20-2 (another apparatus) that the image projection apparatus 10-1 becomes unusable. Further, after finishing the projection, the image projection apparatus 10-1 notifies the image sharing apparatus 20-2 that the image projection apparatus 10-1 becomes usable.

In this way, by the image sharing apparatus 20 notifying the image information storage apparatus 30 of the usage statuses of the one or more image projection apparatuses 10 together with the usage status of itself, convenience of the user who wants to start the projection can be improved.

<Third Example of the Display Process>

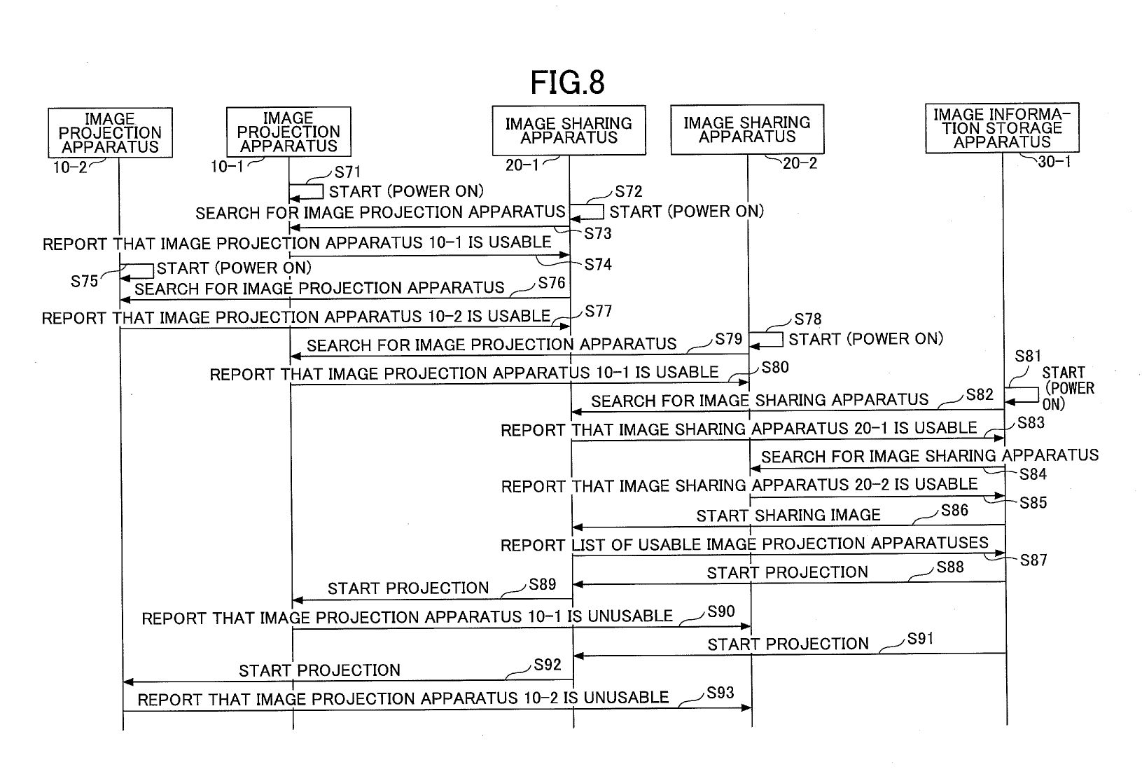

FIG. 8 is a sequence chart illustrating a third example of the display process. In the example shown in FIG. 8, the plurality of image projection apparatuses 10 are used. It should be noted that the sequence shown in FIG. 8 is executed by the two image projection apparatuses 10-1 and 10-2, the two image sharing apparatuses 20-1 and 20-2, and the image information storage apparatus 30-1. Further, because the process in steps S71 to S90 shown in FIG. 8 is similar to the process in steps S31 to S50 shown in FIG. 7, its description is omitted as appropriate.

As shown in FIG. 8, after instructing, in the process in step S88, the image sharing apparatus 20-1 to start the projection while designating the image projection apparatus 10-1, the image information storage apparatus 30-1 instructs the image sharing apparatus 20-1 to start the projection while further designating the image projection apparatus 10-2 in step S91. In response to this, the image sharing apparatus 20-1 causes the image projection apparatus 10-2 to start projecting in step S92. Further, when starting the projection, the image projection apparatus 10-2 notifies the image sharing apparatus 20-2, to which it has been notified that the image projection apparatus 10-2 is usable in the process in step S80, that the image projection apparatus 10-2 is unusable in step S93.

As described above, according to the third example, in a case in which the image sharing apparatus 20-1 receives the instruction for causing the image projection apparatus 10-2 (another apparatus) to start the projection while using the image projection apparatus 10-1 for projecting, the image sharing apparatus 20-1 transmits the image data to be shared to the image projection apparatus 10-2 and causes the image projection apparatus 10-2 to start projecting the image data. In this way, even if a plurality of image projection apparatuses are installed in a large conference room or a plurality of image projection apparatuses are installed in separate conference rooms, an image desired to be shared can be projected by the respective image projection apparatuses.

It should be noted although the image projection apparatus 10-1 and the image projection apparatus 10-2 are instructed to start projecting at different timings in the sequence shown in FIG. 8, the image projection apparatuses 10-1 and 102 may be designated at the same time to start projecting.

<Fourth Example of the Display Process>

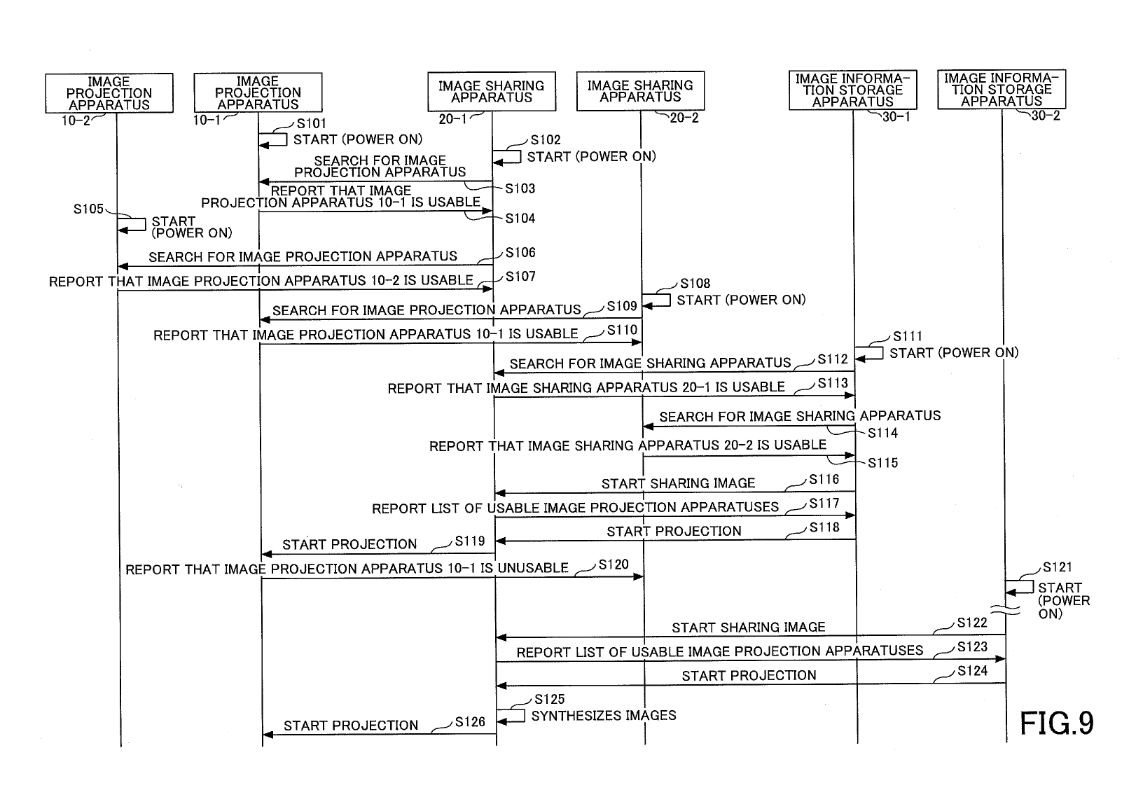

FIG. 9 is a sequence chart illustrating a fourth example of the display process. In the example shown in FIG. 9, when a plurality of projection requests are received from a plurality of the image information storage apparatuses 30 respectively, a plurality of pieces of image data received from the respective image information storage apparatuses 30 are synthesized and displayed.

It should be noted that the sequence shown in FIG. 9 is executed by the two image projection apparatuses 10-1 and 10-2, the two image sharing apparatus 20-1 and 20-2, and the two image information storage apparatuses 30-1 and 30-2. Further, because the process in steps S101 to S121 shown in FIG. 9 is similar to the process in steps S31 to S50 shown in FIG. 7, its description is omitted as appropriate.

As shown in FIG. 9, after being started in the process in step S121, the image information storage apparatus 30-2 instructs the image sharing apparatus 20-1 to start sharing the image in step S122. The image sharing apparatus 20-1 notifies the image information storage apparatus 30-2 of the list of the usable image projection apparatuses 10 in step S123.

When the image projection apparatus 10-1 desired to be used is designated from the list, the image information storage apparatus 30-2 transmits, to the image sharing apparatus 20-1 in step S124, the identification information of the image projection apparatus 10-1 and the image data to be shared together with the instruction for starting the projection.

In step S125, the image sharing apparatus 20-1 synthesizes the currently being projected image data obtained from the image information storage apparatus 30-1 and the image data obtained from the image information storage apparatus 30-2. It should be noted that when synthesizing the plurality of pieces of image data, the plurality of pieces of image data may be divided and displayed at the same time in a plurality of screens (two screens). Further, the respective images may be switched and displayed by providing a tab for switching the images. In step S126, the image sharing apparatus 20-1 transmits the synthesized image data to the image projection apparatus 10-1, and causes the image projection apparatus 10-1 to start projecting.

As described above, according to the fourth example, when the requests for projecting are received from the plurality of image information storage apparatuses 30-1 and 30-2, the plurality of pieces of image data received from the respective image information storage apparatuses 30-1 and 30-2 are synthesized and displayed. In this way, because a plurality of materials can be displayed at the same time for example, the conference can proceed efficiently and the convenience of the user can be improved.

<Fifth Example of the Display Process>

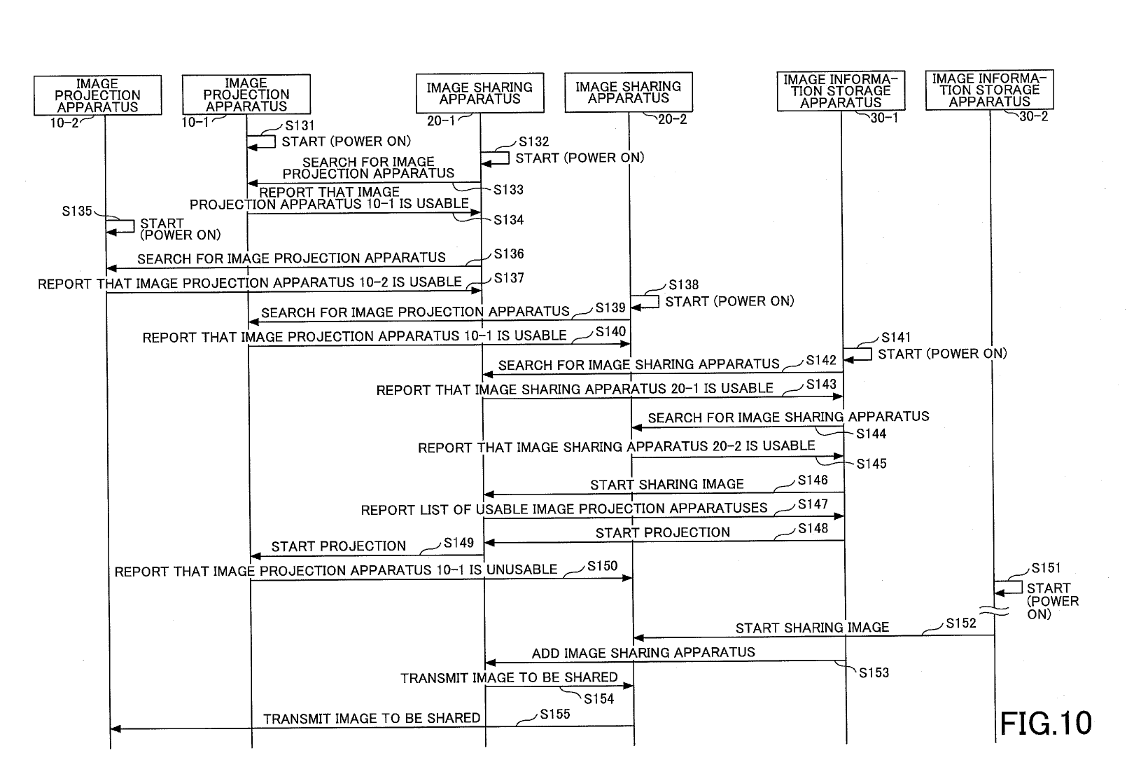

FIG. 10 is a sequence chart illustrating a fifth example of the display process. In the example shown in FIG. 10, the plurality of image sharing apparatuses 20 are cooperated. The sequence shown in FIG. 10 is executed by the two image projection apparatuses 10-1 and 10-2, the two image sharing apparatuses 20-1 and 20-2, and the two image information storage apparatuses 30-1 and 30-2. Further, because the process in steps S131 to S151 shown in FIG. 10 is similar to the process in steps S31 to S50 shown in FIG. 7, its description is omitted as appropriate.

As shown in FIG. 10, after the image information storage apparatus 30-2 instructs, in the process in step S152, the image sharing apparatus 20-2 to start sharing the image, the image information storage apparatus 30-1 instructs the image sharing apparatus 20-1 to add and to use the image sharing apparatus 20-2 in step S153. When the image sharing apparatus 20-1 transmits, to the image sharing apparatus 20-2 in step S154, the image data to be shared, the image sharing apparatus 20-2 transmits the image data to be shared to the image projection apparatus 10-2 and causes the image projection apparatus 10-2 to start projecting in step S155.

As described above, according to the fifth example, when the instruction for adding and using the image sharing apparatus 20-2 (another apparatus) is received from the image information storage apparatus 30-1 while the conference is being held using the image sharing apparatus 20-1, the image data to be projected is shared between the image sharing apparatuses 20-1 and 20-2.

In this way, by the plurality of image sharing apparatuses 20 being cooperated, a load of the image sharing apparatuses 20 can be distributed and the image sharing apparatuses 20 can be realized by low cost hardware. Further, because a communication path of the image sharing apparatuses 20 is limited, a conference with a remote area can be held securely. Thus, cooperation with the other image information storage apparatus 30 that uses the other image sharing apparatus 20 can be performed.

<Example of a Graphical User Interface (GUI)>

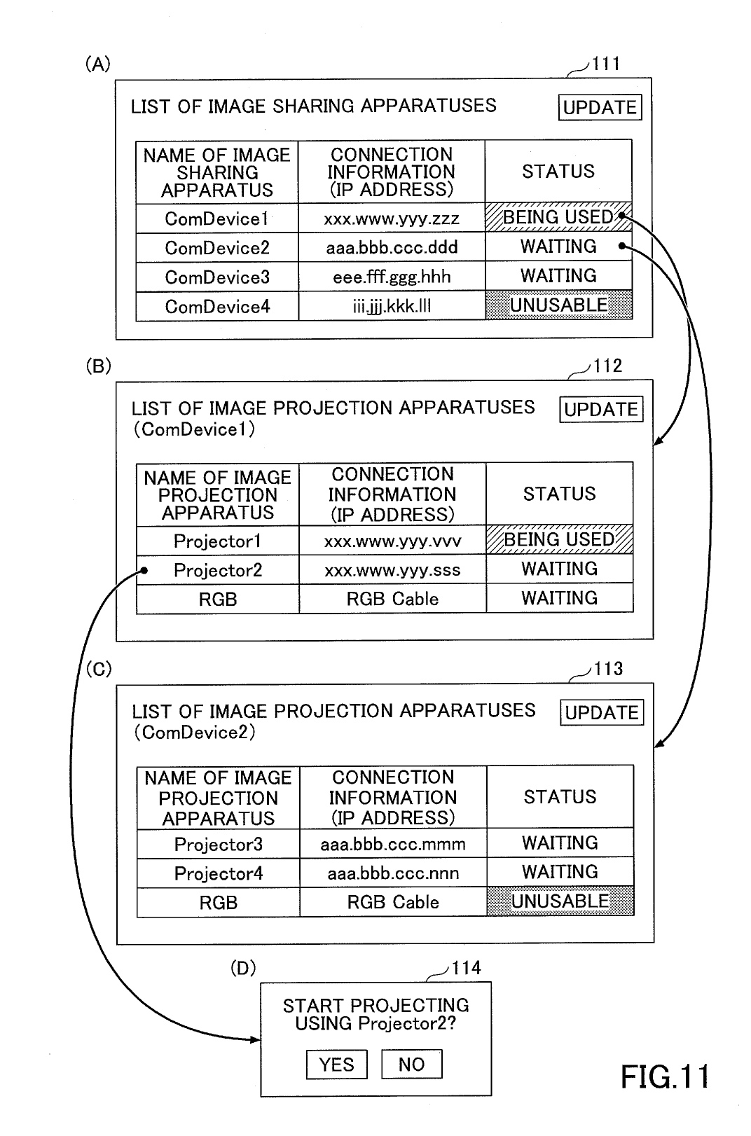

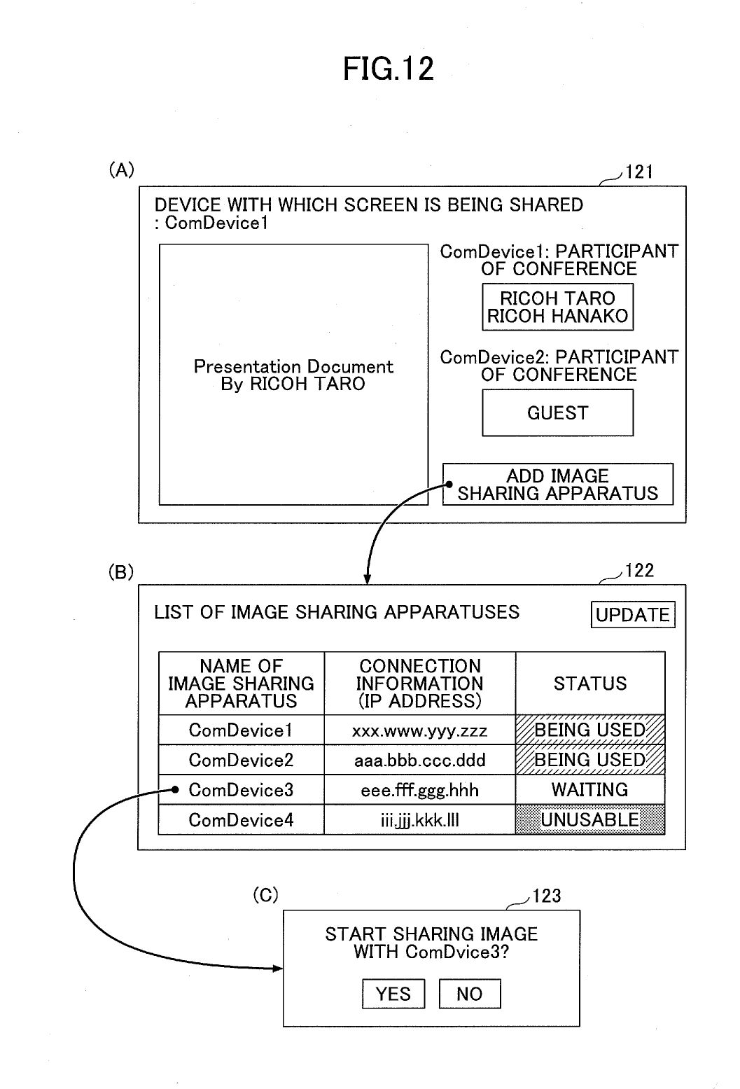

Next, an example of a graphical user interface (GUI) according to the embodiment will be described with reference to FIGS. 11 and 12. FIG. 11 is a drawing illustrating an example of the GUI displayed in the image information storage apparatus 30. In the example shown in FIG. 11, a search result of the image sharing apparatuses 20 is displayed. The search result is obtained by the image information storage apparatus 30 searching for the image sharing apparatuses 20 when the image information storage apparatus 30 is started or the instruction to start sharing the image is executed.

A screen 111 shown in FIG. 11(A) displays the list of the image sharing apparatuses 20 obtained by the search unit 104 of the image information storage apparatus 30 searching. The list of the image sharing apparatuses 20 displays, for example, name of the image sharing apparatuses 20, connection information (IP addresses), and usage statuses.

It should be noted that in the embodiment, the one or more image sharing apparatuses 20 that have been registered previously in the image information storage apparatus 30 may be displayed. For example, when the previously registered image sharing apparatuses 20 is unusable, “UNUSABLE” is displayed in the status as shown in FIG. 11(A).

Further, because information of the usable image sharing apparatuses 20 is changed in accordance with ON/OFF of the power and connection state of the network, the latest search result may be displayed in response to pushing an updating button (“UPDATE”) shown in FIG. 11(A).

Further, when an item button displayed in the “STATUS” in FIG. 11(A) is pushed, as shown in a screen 112 shown in FIG. 11(B) and a screen 113 shown in FIG. 11(C), a list of the image projection apparatuses 10 that can be used by the corresponding image sharing apparatus 20 is displayed. The screen 112 and the screen 113 are examples of the GUI generated by the respective image sharing apparatus 20. Further, the lists shown in the screen 112 and the screen 113 displays names of the image projection apparatuses 10, connection information (IP addresses), and usage statuses. The lists are generated by the list information generation units 77 of the image sharing apparatuses 20, respectively.

It should be noted that the image projection apparatuses 10 displayed in the screen 112 or the screen 113 may include not only the image projection apparatuses 10 connected via the network N1 but also include one or more image projection apparatuses 10 connected via the RGB cable or the like.

Further, in the example shown in FIG. 11, by selecting the name of the image projection apparatus 10 in the screen 112 or the screen 113, the instruction for starting the projection can be performed in a screen 114 shown in FIG. 11(D) while designating the image projection apparatus 10.

FIG. 12 is a drawing illustrating an example of the GUI displayed by the image projection apparatus 10. In the example shown in FIG. 12, the GUI (projection screen) which the image sharing apparatus 20 transmits to the one or more image projection apparatus 10 is displayed.

A screen 121 shown in FIG. 12A is displayed on a screen, a whiteboard, a wall or the like by the image projection apparatus 10. Further, the image sharing apparatus 20 can transmit a GUI similar to the GUI shown in FIG. 12 to the image information storage apparatus 30 that uses the image sharing apparatus 20. Thus, the image information storage apparatus 30 can perform instruction from a remote area via the screen 121.

In the screen 121 shown in FIG. 12(A), in addition to the image data (projection data) being displayed and the name of the image sharing apparatus 20 (ComDevice1) currently performing the projection, a list of the image sharing apparatuses 20 (ComDevice1 and Comdevice2) currently sharing the image, and the information of the users (for example, information of participants of the conference) of the image information storage apparatuses 30 using the image sharing apparatuses 20 (ComDevice1 and Comdevice2).

The information shown in the screen 121 is, for example, obtained by the image sharing apparatus 20 cooperating with the other image sharing apparatus 20 via the network N2. It should be noted that when the image sharing apparatus 20 communicates with the image information storage apparatus 30, the information of the user of the image information storage apparatus 30 can be obtained by exchanging account (login) information of the image information storage apparatus 30.

Further, when a button for adding the image sharing apparatus 20 is pushed in the screen 121 shown in FIG. 12(A), a screen 122 is displayed in which a list of usable image sharing apparatuses 20 are shown. The list of the image sharing apparatuses 20 is generated by the image information storage apparatus 30 as described above.

When a button corresponding to the name of the image sharing apparatus 20 is pushed in the screen 122 shown in FIG. 12(B), the image information storage apparatus 30 displays a screen 123 shown in FIG. 12(C). Thus, for example, an image sharing apparatus 20 desired to be added to the conference can be selected. It should be noted that “WAITING” shown in FIGS. 11 and 12 indicates that the corresponding apparatus is usable.

According to the above described embodiment, by designating the one or more image projection apparatuses 10 via the image sharing apparatus 20 from the image information storage apparatus 30, which is the supply source of the image to be shared, using the network, cables which have been used in a conventional system between the image sharing apparatus 20 and the one or more image projection apparatuses 10 can be omitted. Further, a cable between the image sharing apparatus 20 and the image information storage apparatus 30 can be omitted. Further, the image projection apparatus 10 and the image sharing apparatus 20 are not required to connect with each other in one-to-one correspondence via the cable, the image projection apparatus 10 arranged at the remote area or on the ceiling can be used. Thus, the convenience of the user can be improved.

Further, the present invention is not limited to these embodiments, but various variations and modifications may be made without departing from the scope of the present invention.

What is claimed is:

1. A display control apparatus comprising:
a search unit configured to search for one or more display apparatuses connected to a network;
a notification unit configured to notify, in response to receiving an output request for outputting data from an information processing apparatus via the network, the information processing apparatus of usage statuses of the one or more display apparatuses obtained by the search unit; and
an output control unit configured to cause a display apparatus, selected by the information processing apparatus among the one or more display apparatuses whose usage statuses have been notified from the notification unit, to output the data.

2. The display control apparatus according to claim 1, further comprising a usage status monitoring unit configured to monitor the usage statuses of the one or more display apparatuses at fixed intervals or when being started.

3. The display control apparatus according to claim 1, wherein the output control unit is configured to cause two or more display apparatuses, selected by the information processing apparatus, to output the data.

4. The display control apparatus according to claim 1, further comprising a cooperation management unit configured to synthesize or switch, in response to receiving a plurality of output requests for outputting data from a plurality of information processing apparatuses, the data received from the plurality of information processing apparatuses,
wherein the output control unit is configured to cause the display apparatus to display the data synthesized or switched by the cooperation management unit.

5. The display control apparatus according to claim 4, wherein the cooperation management unit is configured to share, in response to receiving designation for adding another display control apparatus connected to the network from the information processing apparatus, the data being output to the display apparatus with the other display control apparatus.

6. The display control apparatus according to claim 1, further comprising a screen generation unit configured to generate a screen for selecting the display apparatus among a list of the one or more display apparatuses connected to the network.

7. The display control apparatus according to claim 1, further comprising:
an updating unit configured to update the usage statuses of the one or more display apparatuses based on a change of at least one of the one or more display apparatuses from a usable state to an unusable state and a change of the at least one of the one or more display apparatuses from the unusable state to the usable state,
wherein the notification unit is configured to notify the information processing apparatus of the usage statuses of the one or more display apparatuses updated by the updating unit.

8. A display control system comprising:
one or more display apparatuses configured to display data;
an information processing apparatus configured to output the data to the one or more display apparatuses; and
a display control apparatus configured to relay the data between the one or more display apparatuses and the information processing apparatus, the one or more display apparatuses, the information processing apparatus, and the display control apparatus being connected to a network,
wherein the display control apparatus includes,
a search unit configured to search for the one or more display apparatuses connected to the network;
a notification unit configured to notify, in response to receiving an output request for outputting the data from the information processing apparatus via the network, the information processing apparatus of usage statuses of the one or more display apparatuses obtained by the search unit; and
an output control unit configured to cause a display apparatus, selected by the information processing apparatus among the one or more display apparatuses whose usage statuses have been notified from the notification unit, to output the data.

9. A graphical user interface executed in a display control system in which one or more display apparatuses configured to display data, an information processing apparatus configured to output the data to the one or more display apparatuses, and a display control apparatus configured to relay the data between the one or more display apparatuses and the information processing apparatus are connected to a network, the graphical user interface comprising:
a cooperation management unit configured to obtain, from the display control apparatus, information of a user of the information processing apparatus who shares the data displayed by the one or more display apparatuses; and
a screen generation unit configured to generate a screen for displaying, together with the data, the information of the user of the information processing apparatus obtained by the cooperation management unit.
